(19) United States
(12) Patent Application Publication
(10) Pub. No.: US 2017/0298462 A1
(43) Pub. Date: Oct. 19, 2017

(54) Method For Producing A Structural Component Including A Thermomagnetic Tempering Process Yielding Localized Soft Zones

(71) Applicant: MAGNA INTERNATIONAL INC., Aurora (CA)

(72) Inventors: Richard Lee WINFREE, Knoxville, TN (US); Edward K. STEINEBACH, Oak Ridge, TN (US); Mark Justin JONES, Knoxville, TN (US); Jeremiah John BRADY, Knoxville, TN (US); Kenneth Ray ADAMS, Troy, MI (US); Gerard M. LUDTKA, Oak Ridge, TN (US); Kenneth James THERRIEN, Oak Ridge, TN (US)

(21) Appl. No.: 15/513,315

(22) PCT Filed: Sep. 18, 2015
(86) PCT No.: PCT/IB2015/002018

§ 371 Date: Mar. 22, 2017

Related U.S. Application Data
(60) Provisional application No. 62/053,280, filed on Sep. 22, 2014.

(51) Int. Cl. C21D 1/04; C21D 1/673; B62D 25/06; B62D 29/00; B62D 25/04

(52) U.S. Cl. CPC C21D 1/04; C21D 1/673; C21D 2211/008; C21D 2211/005; B62D 25/04; B62D 29/007; B62D 25/06; C21D 2221/00; C21D 2211/003

(57) ABSTRACT

The invention relates generally to structural steel components for automotive vehicles, and methods for manufacturing the structural components. The method includes heating a workpiece to at least 900° C. to form austenite in the steel material, hot forming the workpiece, and quenching the formed workpiece to transform the austenite to martensite. The method next includes tempering at least one portion of the quenched workpiece, wherein the tempering step includes simultaneously applying thermal energy and a magnetic field to the workpiece. During the tempering step, the martensite of the steel material transforms to a mixture of ferrite and cementite precipitates. The portions of the steel material subject to the thermomagnetic tempering are also typically free of pearlite and spheroid particles. The remainder of the workpiece is protected during the tempering step to maintain a hard zone including the martensite.

### CROSS REFERENCE TO RELATED APPLICATIONS

This PCT Patent Application claims the benefit of and priority to U.S. Provisional Patent Application Ser. No. 62/053,280 filed Sep. 22, 2014, the entire disclosure of the application being considered part of the disclosure of this application, and hereby incorporated by reference.

### STATEMENT REGARDING FEDERALLY SPONSORED RESEARCH

The Government has rights in this invention pursuant to Work for Others Agreement No. NFE-13-04839 awarded by the Department of Energy.

### BACKGROUND OF THE INVENTION

### 1. Field of the Invention

The invention relates generally to structural components formed of steel for automotive vehicles, and methods for manufacturing the structural components.

### 2. Related Art

Steel structural components for automotive vehicles are oftentimes hot-formed and quenched to form a martensitic microstructure, which provides high hardness and strength. However, depending on the particular application of the structural component, it may be desirable to reduce the hardness or increase the ductility in certain zones of the structural component. For example, soft zones may be formed to improve the performance of the component upon impact or improve the weldability of the component. Such localized soft zones can be formed by a tempering process. However, known tempering processes require a significant amount of time and thermal energy, and thus there remains a need for more efficient tempering processes.

### SUMMARY OF THE INVENTION

The invention provides a method of manufacturing a structural component, such as a component for an automotive vehicle, with an improved tempering process. The method includes providing a workpiece formed of steel material; heating and forming the workpiece; quenching the formed workpiece; and tempering at least one portion of the quenched workpiece. The tempering step includes simultaneously applying thermal energy and a magnetic field to the workpiece. This thermomagnetic tempering process is more efficient than other tempering processes, and thus reduces costs associated with manufacturing the structural component.

The invention also provides a structural component including at least one hard zone, and at least one soft zone adjacent the at least one hard zone. The at least one hard zone includes martensite and the at least one soft zone includes a mixture of ferrite and cementite.

The invention further provides a structural component formed by a process comprising the steps of: heating and forming the workpiece; quenching the formed workpiece; and tempering at least one portion of the quenched workpiece. The tempering step includes simultaneously applying thermal energy and a magnetic field to the workpiece.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 illustrates example structural components of an automotive vehicle including at least one soft zone formed by a thermomagnetic tempering process;

FIG. 2 illustrates another example structural component including a soft zone formed by a thermomagnetic tempering process;

FIG. 3 illustrates a typical tempered microstructure of a Fe-0.2C alloy;

FIG. 4 is a table listing stages of an example steel tempering process;

FIG. 5 is a table listing reactions that occur during an example steel tempering process;

FIGS. 6A-6C illustrate a microstructure including low-carbon martensite;

FIGS. 7A-7C illustrate a microstructure including high-carbon plate martensite;

FIGS. 8A-8B illustrate a steel microstructure with spheroid particles; and

FIG. 9 illustrates results of an experiment comparing the thermomagnetic tempering process of the present invention to a conventional tempering process.

### DESCRIPTION OF THE ENABLING EMBODIMENT

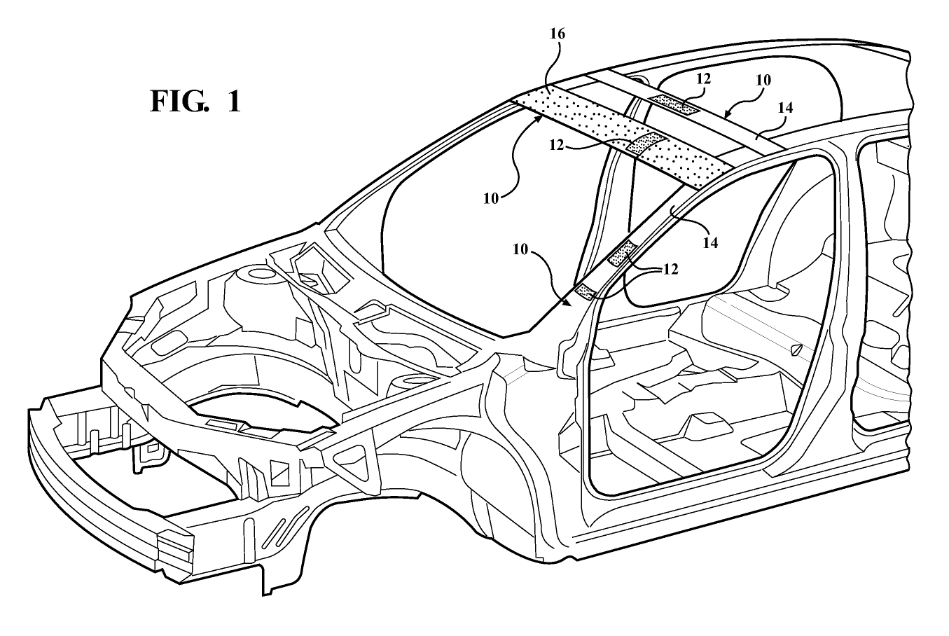

The invention provides an improved method of manufacturing a structural component 10, typically for an automotive vehicle application, such as a pillar, header, rail, twist axle, spring link, control arm, bumper, beam, side panel, or any other type of strength driven chassis component, body in white component, or safety-related component. However, the structural component 10 could alternatively be used in non-automotive applications. The structural component 10 is hot-formed, quenched, and then tempered using a thermomagnetic tempering process to form at least one localized soft zone 12 adjacent a hard zone 14, and optionally a transition zone 16. FIG. 1 illustrates example structural components 10, including an A-pillar, header, and roof rail, each including at least one localized soft zone 12 formed by the thermomagnetic tempering process. FIG. 2 illustrates another example automotive rail including at least one localized soft zone 12 formed by the thermomagnetic tempering process. The thermomagnetic tempering process is able to achieve greater localized softening at a faster rate, compared to other tempering processes which do not employ magnetic fields.

The method begins by providing at least one workpiece, such as a sheet or blank, formed of a steel material. The steel material of the workpiece can comprise any type of steel, including low carbon steel, medium carbon steel, ultra-high strength steel (UHSS), advanced high strength steel (AHSS), or high strength steel (HSS). A dual-phase steel material or a mixture of different materials can also be used to form the structural component 10. The workpiece should have an appropriate size and thickness depending on the type of structural component 10 to be formed.

The method next includes hot forming the workpiece to achieve a predetermined shape, which depends on the type of structural component 10 to be formed. Any type of hot forming process can be used to shape the workpiece. In one example embodiment, the hot forming process first includes heating the workpiece to a predetermined temperature in a furnace. The predetermined temperature depends on the type of steel material of the workpiece, the geometry of the workpiece, the desired geometry of the structural component 10, and possibly other factors. The workpiece is typically heated to a temperature high enough to form austenite in the steel material, for example at least 900° C.

Once the workpiece reaches the predetermined temperature sufficient for hot forming, the heated workpiece is quickly transferred to a hot forming apparatus, such as a die, press, or stamping device. The hot forming apparatus typically includes an upper die presenting an upper forming surface and a lower die presenting a lower forming surface. The heated workpiece is disposed between the two forming surfaces. The shape of the upper die and lower die varies depending on the desired geometry of the structural component to be formed. The upper and lower dies are typically formed of steel, but can be formed of other materials. The upper and lower dies also typically include a cooling means, such as a plurality of cooling channels spaced from the forming surfaces.

The forming step typically begins immediately or shortly after the heated workpiece is disposed between the upper and lower dies, and while the workpiece is still at a temperature of at least 900° C., or close to the temperature achieved in the furnace. During the forming step, the upper and lower dies are pressed together to stamp, press, or otherwise form the workpiece to the desired geometry. In one embodiment, the forming step includes stamping the hot workpiece between the upper and lower dies to achieve the desired geometry, specifically by engaging the hot workpiece with the upper and lower dies and applying pressure to the hot workpiece using at least one of the upper and lower dies. In the example embodiment, the workpiece is heated to a temperature of at least 900° C. in the furnace, so that austenite is present in the steel material of the workpiece during the forming step. The workpiece can be formed to various different and complex geometries, depending on the desired application of the structural component.

Immediately after or during the forming step, the method includes quenching the workpiece, preferably in the hot forming apparatus. This step is referred to as tool-quenching. At the bottom of the forming stroke, when the upper and lower dies are pressed together, water or another cooling fluid can flow through the cooling channels of the dies to quench the workpiece. The quenching step causes a phase transformation in the steel material and increases the strength of the steel material. During the quenching step, the steel material reaches a temperature low enough to cause the austenitic microstructure to transform to a martensitic microstructure, which increases the strength of the steel material.

The method next includes the thermomagnetic tempering process to form the at least one localized soft zone 12. As alluded to above, use of the magnetic field during the tempering process accelerates tempering kinetics and achieves localized softening at a faster rate, compared to other tempering processes which do not employ magnetic fields. The thermomagnetic tempering process includes first determining which areas of the hot formed, tool-quenched workpiece should include the at least one localized soft zone 12. The predetermined area of the workpiece in which the soft zones 12 are formed depends on the desired application of the structural component 10. For example, one of the soft zones 12 could be located at a distal end of the structural component 10, or in a transition region. Any number of soft zones 12 can be formed using the improved thermomagnetic tempering process. Alternatively, the thermomagnetic tempering process can be applied to the entire workpiece to provide the soft zone 12 throughout the entirety of the structural component 10.

Once the predetermined area of the workpiece is selected, the thermomagnetic tempering process begins by disposing a magnet adjacent the predetermined area for applying the magnetic field to the predetermined areas. The method also includes disposing a heat source adjacent the predetermined area for applying the thermal energy while applying the magnetic field. Any type of magnet and any type of heat source can be used to simultaneously apply the magnetic field and thermal energy. The geometry of the magnet and heat source, however, is selected based on the geometry of the workpiece, and should be capable of providing the localized magnetic field and thermal energy to the predetermined areas. In the example embodiment, the magnetic field is provided by a superconducting magnet, in the form of a flat plate with a bore, and the predetermined area of the workpiece is disposed in the bore. Alternatively, a conventional electromagnet can be used. The workpiece is typically held in a fixture or tempering station which includes the magnet and heat source.

The thermomagnetic tempering process next includes applying the magnetic field and thermal energy to the predetermined area to form the at least one localized soft zone 12. The magnitude of the magnetic field and temperature applied to the predetermined area can vary depending on the geometry of the workpiece and the desired microstructure to be achieved in the at least one soft zone 12. Typically, during the thermomagnetic tempering process, the heat source heats the predetermined area to a temperature ranging from 300° C. to 500° C., and the magnet applies a magnetic field ranging from 1 to 3 tesla. In one example embodiment, the heat source heats the predetermined area to a temperature around 450° C., and the magnet applies a magnetic field around 2 tesla. The duration of the thermomagnetic tempering process can vary depending on the geometry of the workpiece and the desired microstructure to be achieved in the at least one soft zone 12. The temperature, magnetic field, and/or duration of the thermomagnetic tempering process can be adjusted such that the martensitic microstructure of the predetermined area transitions to the desired microstructure. The microstructure of the at least one soft zone 12 is more stable and has a hardness less than the hardness of the martensitic microstructure present prior to the tempering process.

In the example embodiment, the workpiece comprises a low carbon steel, such a Fe-0.2C alloy. The thermomagnetic tempering process of this embodiment includes disposing the workpiece in the bore of the superconducting magnet, and heating the predetermined area of the workpiece to a temperature of 450° C. while applying a magnetic field of 2 tesla for 25 minutes to form the soft zone 12. During thermomagnetic tempering process, the martensite of the hot-formed, tool-quenched workpiece transitions from a bct martensitic microstructure to a mixture of bcc iron, referred to as ferrite, and carbide (Fe₃C) precipitates. It is known that the ferrite and the carbide will coarsen with increasing time and temperature, due to the reduction of interfacial energy between the precipitates and the ferrite matrix. See Reference 18 of George F. Vander Voort, ASM Handbook: Volume 9: Metallography And Microstructures, ASM International, 2004, ISBN-13:978-0871707062, ISBN-10:0871707063, referred to hereinafter as “the ASM Handbook.” No pearlite is present in the tempered microstructure of this embodiment. Preferably the hardness achieved by the thermomagnetic tempering process is 200 VHN, or about 670 MPa UTS.

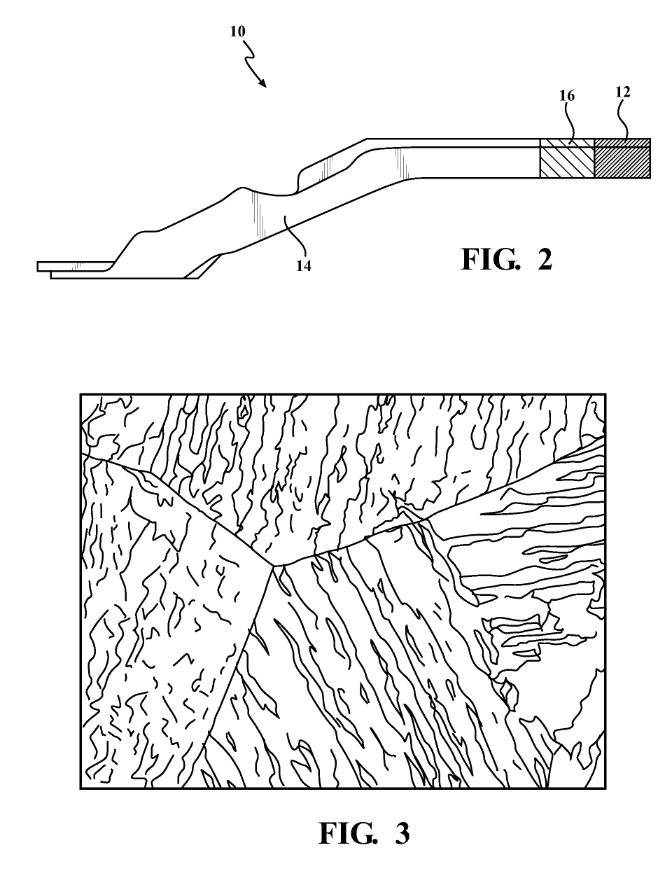

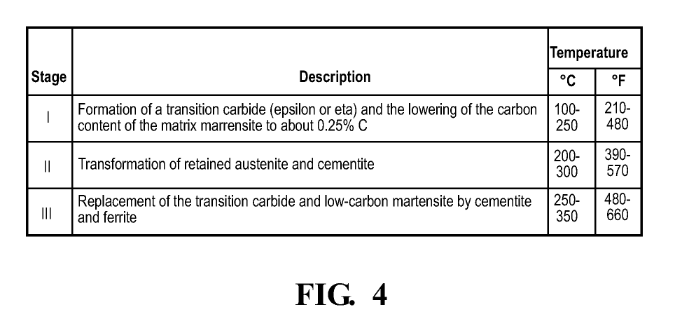

A typical tempered microstructure for a Fe-0.2C alloy is shown in FIG. 3, which was obtained from Reference 18 of the ASM Handbook. FIG. 4 was obtained from Reference 3 of the ASM Handbook and illustrates stages of an example steel tempering process. In the example process, formation of a transition carbide (epsilon or eta) and lowering of the carbon content of the matrix martensite to about 0.25% carbon occurs at temperatures ranging from 100° C. to 250° C. At a temperatures ranging from 200° C. to 300° C., the process includes transformation of retained austenite to ferrite and cementite. At temperatures ranging from 250° C. to 350° C., the process includes replacement of the transition carbide and low-carbon martensite with cementite and ferrite.

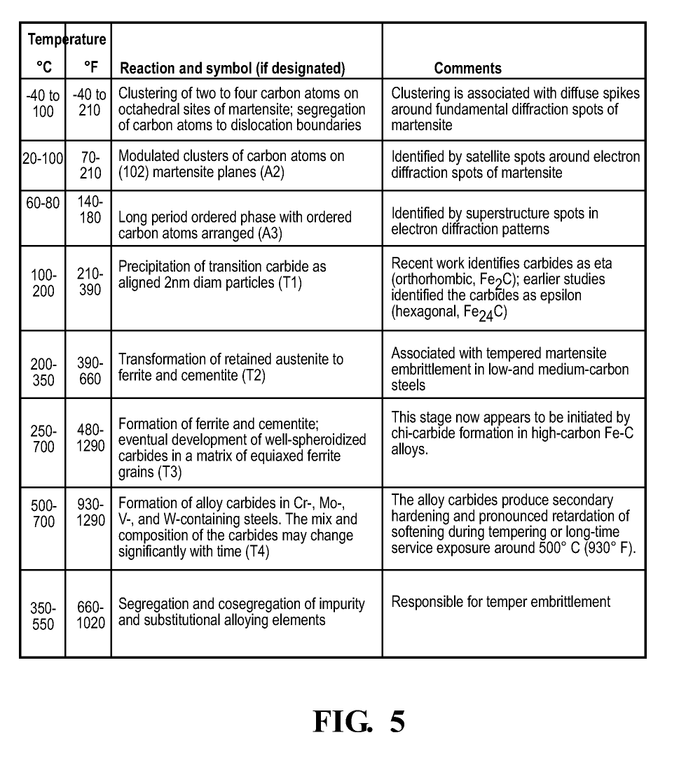

FIG. 5 was obtained from Reference 5 of the ASM Handbook and illustrates reactions that occur in an example steel tempering process at temperatures ranging from −40° C. to 550° C. It is noted that both time and temperature are important variables used to achieve the desired microstructure, strength, and ductility during the tempering process. The following tempering parameter is often used to describe the interaction between time and temperature: T (20+log t)×10⁻³ where T is temperature in Kelvin and t is time in hours. See Reference 3 of the ASM Handbook.

The amount of softening that occurs with tempering can be altered by adding alloy elements to the steel material of the workpiece. Softening typically occurs by the diffusion-controlled coarsening of cementite, and strong carbide formers, such as chromium, molybdenum, and vanadium, can reduce the rate of coarsening. Additionally, at higher tempering temperatures, the alloying elements themselves may form carbides, leading to an increase in overall hardness. See Reference 3 of the ASM Handbook.

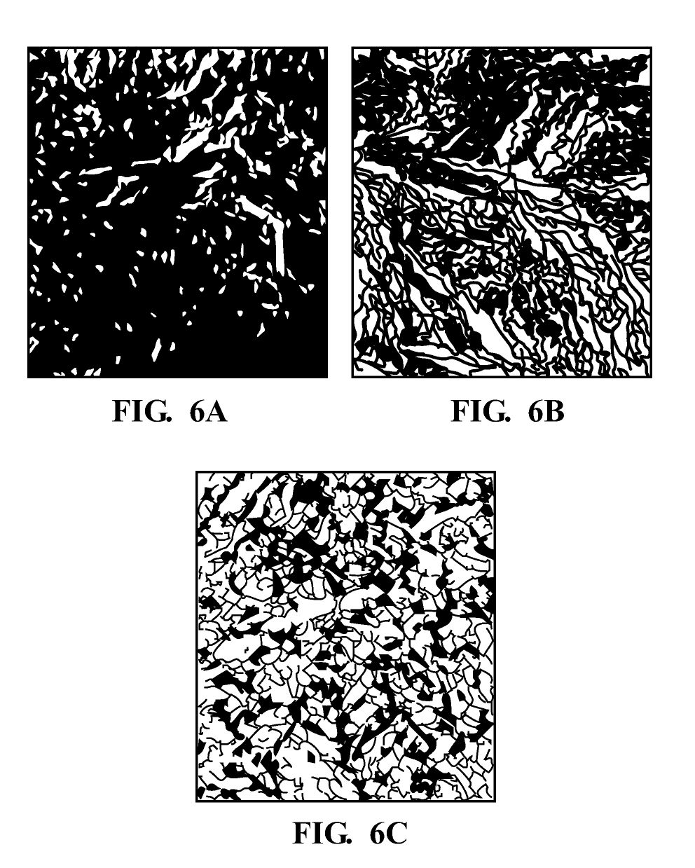

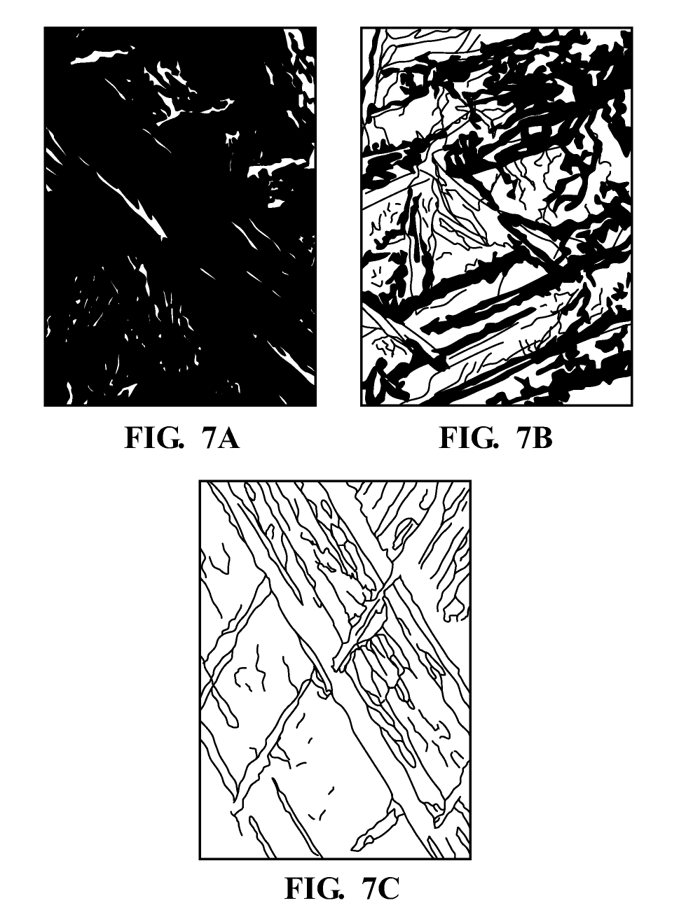

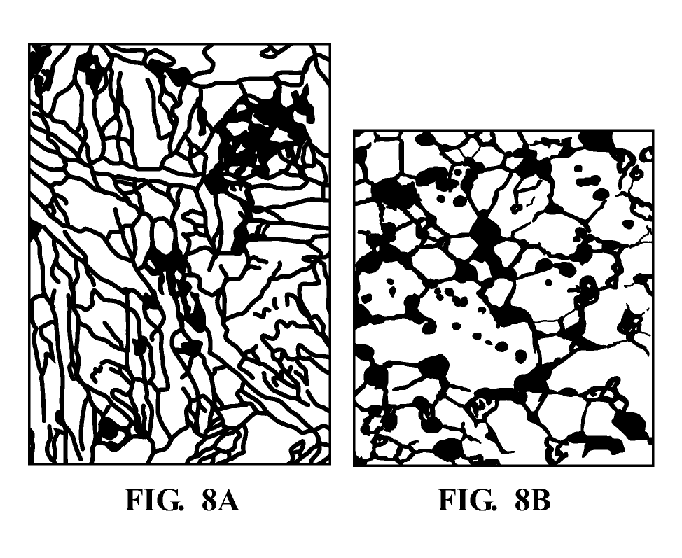

In addition, different morphologies of tempered martensite can form depending on the original martensite microstructure. It has been observed that packets of aligned laths in low-carbon martensite can transform into large, acicular grains, as shown in FIGS. 6A-6C, which was obtained from Reference 18 of the ASM Handbook. In higher-carbon plate martensite, large martensite plates can transform to equiaxed grains upon tempering, as shown in FIGS. 7A-7C. The tempering parameters should also be chosen to avoid spheroidization, wherein the Fe₃C coalesces to form spheroid particles, as shown in FIGS. 8A-8B. FIGS. 7A-7C and 8A-8B were also obtained from Reference 18 of the ASM Handbook.

Although the thermomagnetic tempering process typically yields soft zones 12 comprising a mixture of ferrite and carbide, wherein the carbide is cementite (Fe₃C) the temperature, magnetic field, and/or duration of the thermomagnetic tempering process could be adjusted to form other microstructures and hardness levels. For example, the martensite transforms such that the microstructure of the at least one soft zone 12 could include a mixture of ferrite and pearlite. In addition, if multiple soft zones 12 are formed, different microstructures and hardness levels can be formed in each soft zone 12. The microstructure of the soft zones 12 formed by the thermomagnetic tempering process can vary depending on the application of the structural component 10.

During the thermomagnetic tempering process, select regions of the workpiece wherein soft zones 12 are not desired are protected from the thermal energy and magnetic field in order to maintain the martensitic microstructure. In other words, certain portions of the workpiece are protected to prevent the martensitic microstructure present at the end of the hot-forming and quenching steps from transforming to a softer microstructure. Any known method can be used to mask or otherwise protect these select regions from the magnetic field and thermal energy. The select regions present in the finished structural component 10 are referred to as hard zones 14, and their location varies depending on the desired application of the structural component 10.

In addition to forming the soft zones 12 by applying the magnetic field and thermal energy to predetermined regions of the workpiece, and retaining hard zones 14 by masking the select regions of the workpiece, the method can also include forming the at least one transition zone 16 by at least partially protecting or tempering certain areas of the workpiece. The areas of the workpiece wherein the transition zones 16 are desired can partially masked or partially tempered, such that they are only exposed to a portion of the magnetic field and/or thermal energy. For example, the tempering step can include masking a first portion of the workpiece to maintain the hard zone 14, simultaneously applying the thermal energy and the magnetic field each at a first level to a second portion of the workpiece to form the soft zone 12, and simultaneously applying the thermal energy and the magnetic field each at a second level lower than the first level to a third portion of the workpiece to form the transition zone 16 between the hard zone 14 and the soft zone 12.

The location of the transition zones 16 varies depending on the desired application of the structural component 10. However, each transition zone 16 is typically disposed between one of the hard zones 14 and one of the soft zones 12. FIG. 2 illustrates an example structural component 10 including the transition zone 16.

The microstructure of the transition zone 16 has a hardness which is between the hardness of the adjacent hard zone 14 and the hardness of the adjacent soft zone 12. For example, the transition zone 16 can comprise at least one of martensite, ferrite, pearlite, cementite, and bainite. Typically, the transition zone 16 comprises a mixture of different microstructures, for example a mixture of ferrite and pearlite.

The method can also optionally include a conventional tempering process in addition to the thermomagnetic tempering process. For example, a second tempered zone can be formed, wherein the second tempered zone has a microstructure and hardness different from those of the soft zones 12, the hard zones 14, and the transition zone 16.

The hot-formed, quenched, and tempered structural component 10 formed by the method can optionally be finished machined or otherwise further prepared for the desired application. For example, after the thermomagnetic tempering step, the method can include trimming, piercing, or welding the structural component 10.

As discussed above, the structural component 10 provided by the invention includes the at least one soft zone 12 formed by the thermomagnetic tempering process disposed adjacent the at least one hard zone 14. The soft zones 12 have a microstructure different from the hard zone 14, a hardness less than the hardness of the hard zone 14, and are more stable than the hard zone 14. The microstructure of the soft zones 12 typically comprises a mixture of ferrite and carbide, wherein the carbide is cementite (Fe₃C). However, soft zones 12 having other microstructures could be formed by the thermomagnetic tempering process. The structural component 10 can also include the transition zone 16 and/or the second tempered zone.

Example structural components 10 with soft zones 12 formed by the thermomagnetic tempering process are shown in FIGS. 1 and 2. FIG. 1 illustrates an example A-pillar, header, and rail of an automotive vehicle. The A-pillar includes two soft zones 12 located along the window area and spaced from one another by the hard zone 14. The hard zone 14 also extends along the roof of the vehicle. The roof rail and header of FIG. 1 each include one soft zone 12. The soft zone 12 of the header is surrounded by the transition zone 16, and the soft zone 12 of the roof rail is surrounded by the hard zone 14. In other cases, the structural component 10 can includes flanges for welding to another component, wherein soft zones 12 are formed along the flanges to improve the weldability of the flanges to the other component. In the example rail of FIG. 2, the soft zone 12 is formed at a distal end of the rail, the hard zone 14 extends from the opposite end toward the soft zone 12, and the transition zone 16 is located between the soft zone 12 and the hard zone 14. The soft zones 12 typically comprise a mixture of ferrite and carbide, wherein the carbide is cementite (Fe₃C), but alternatively the soft zones 12 could include other microstructures having a hardness less than the hardness of the hard zone 14. For example, in the example rail of FIG. 2, the soft zones 12 could comprise a mixture of ferrite and pearlite.

### EXPERIMENT

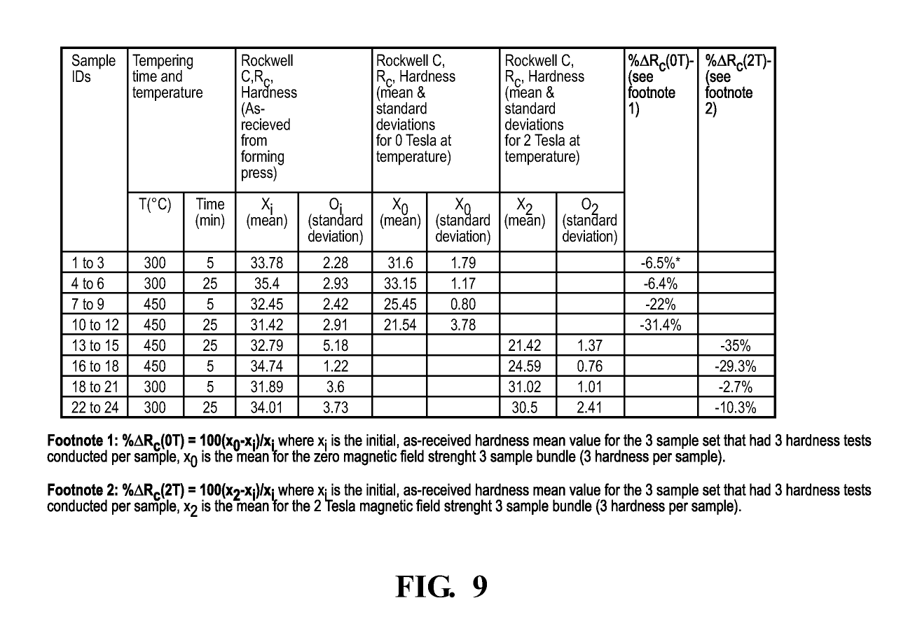

An experiment was conducted to compare the thermomagnetic tempering process of the present invention to a conventional tempering process. The experiment first included measuring the Rockwell Hardness (R_{c}) of a first set of hot-formed, tool-quenched steel samples, as received from a forming press, before any tempering. The experiment next included measuring the Rockwell Hardness (R_{c}) of a second set of samples which were hot-formed and tool-quenched in the same manner as the first set, after tempering without applying a magnetic field. The temperature of the tempering process ranged from 300° C. to 450° C., and the tempering time was either 5 or 25 minutes. The experiment also included measuring the Rockwell Hardness (R_{c}) of a third set of samples also hot-formed and tool-quenched in the same manner as the first two sets, after tempering with a magnetic field applied at 2 tesla. The magnetic field was applied by placing each sample inside a bore of a superconducting magnetic. Other than the magnetic field, the same tempering process parameters were applied to the second and third set of samples. The results of the experiment are shown in FIG. 9 and indicate that the samples subjected to the magnetic field during the tempering process experienced a larger drop in hardness than the samples which were not exposed to the magnetic field. Accordingly, the experiment shows that the thermomagnetic tempering process provides a more efficient method of forming soft zones 12 in a structural component 10.

Obviously, many modifications and variations of the present invention are possible in light of the above teachings and may be practiced otherwise than as specifically described while within the scope of the following claims.

1. A method of manufacturing a structural component, comprising the steps of:
providing a workpiece formed of steel material;
heating and forming the workpiece;
quenching the formed workpiece; and
tempering at least one portion of the quenched workpiece, the tempering step including simultaneously applying thermal energy and a magnetic field to the workpiece.

2. The method of claim 1, wherein the tempering step includes heating to a temperature of 300° C. to 500° C.

3. The method of claim 1, wherein the step of applying the magnetic field includes disposing a superconducting magnet or an electromagnet adjacent the quenched workpiece.

4. The method of claim 1, wherein the tempering step includes masking a first portion of the workpiece to maintain a hard zone, simultaneously applying the thermal energy and the magnetic field each at a first level to a second portion of the workpiece to form a soft zone, and simultaneously applying the thermal energy and the magnetic field each at a second level lower than the first level to a third portion of the workpiece to form a transition zone between the hard zone and the soft zone.

5. The method of claim 1, wherein the heating step includes heating to a temperature high enough to form austenite, the quenching step includes transforming the austenite to martensite, and the tempering step includes transforming the martensite present in the at least one portion of the workpiece to a mixture of ferrite and cementite.

6. The method of claim 5, wherein the tempering step includes protecting at least one portion of the workpiece to maintain the martensite after the tempering step.

7. The method of claim 6, wherein the tempering step includes forming the mixture of ferrite and cementite in a plurality of portions of the workpiece.

8. A structural component, comprising:
at least one hard zone including martensite; and
at least one soft zone adjacent said at least one hard zone, wherein said at least one soft zone includes a mixture of ferrite and cementite.

9. The structural component of claim 8, wherein said at least one soft zone is free of pearlite and spheroid particles.

10. The structural component of claim 8 wherein said hard zone and said soft zone are formed from low carbon steel.

11. The structural component of claim 8 including a transition zone between one of said hard zones and one of said soft zones, wherein the hardness of said transition zone is between the hardness of said soft zone and the hardness of said hard zone.

12. The structural component of claim 11, wherein said transition zone includes a mixture of ferrite and pearlite.

13. The structural component of claim 8, wherein said structural component is a chassis component, body in white component, or safety-related component for an automotive vehicle.

14. The structural component of claim 8 produced by a process comprising the steps of:
providing a workpiece formed of steel material;
heating the workpiece to a temperature high enough to form austenite;
forming the heated workpiece;
quenching the formed workpiece to transform the austenite to martensite; and tempering at least one portion of the quenched workpiece to transform the martensite present in the at least one portion to a mixture of ferrite and cementite, wherein the tempering step includes simultaneously applying thermal energy and a magnetic field to the workpiece.

15. A structural component produced by a process comprising the steps of:
providing a workpiece formed of steel material;
heating and forming the workpiece;
quenching the formed workpiece; and
tempering at least one portion of the quenched workpiece, the tempering step including simultaneously applying thermal energy and a magnetic field to the workpiece.

16. The method of claim 1, wherein the step of forming the workpiece is conducted by at least one of an upper die and a lower die while the workpiece is at a temperature of at least 900° C.

17. The method of claim 1, wherein the forming step is conducted by at least one of an upper die and a lower die of a hot forming apparatus, and the quenching step is conducted in the hot forming apparatus.

18. The method of claim 1, wherein the tempering step includes applying a magnetic field of 1 to 3 tesla.

19. The method of claim 1, wherein the tempering step includes transforming martensite of the at least one portion of the quenched workpiece to ferrite and carbide (Fe₃C) precipitates.

20. The structural component of claim 8, wherein the at least one soft zone includes ferrite and carbide (Fe₃C) precipitates, and the at least one soft zone does not include pearlite.
